(19) United States
(12) Patent Application Publication
(10) Pub. No.: US 2002/0136118 A1
(43) Pub. Date: Sep. 26, 2002

(54) Information recording medium having secret area, information recording apparatus capable of recording information in secret area, and information playback apparatus capable of playing back information from secret area

(76) Inventor: Hideki Takahashi, Kashiwa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/101,690

(22) Filed: Mar. 21, 2002

(30) Foreign Application Priority Data
Mar. 22, 2001 (JP) 2001-083669

(51) Int. Cl. G11B 7/0045; G11B 7/24

(52) U.S. Cl. 369/47.14; 369/59.25; 369/275.3; 369/59.21

(57) ABSTRACT

An information recording medium includes a user area defined by a logical address and a physical address, a secret area defined only by a physical address, and an address area which stores the physical address that indicates the position of the secret area.

### CROSS-REFERENCE TO RELATED APPLICATIONS

This application is based upon and claims the benefit of priority from the prior Japanese Patent Application No. 2001-083669, filed Mar. 22, 2001, the entire contents of which are incorporated herein by reference.

### BACKGROUND OF THE INVENTION

1. Field of the Invention

The present invention relates to an information recording medium such as a DVD (Digital Video Disk) characterized by high-density recording and, more particularly, to a rewritable information recording medium. The present invention also relates to an information recording apparatus for recording information on such an information recording medium. The present invention also relates to an information playback apparatus for playing back information from such an information recording medium.

2. Description of the Related Art

In recent years, DVDs have been extensively studied. DVDs are roughly classified into read-only DVD-ROMs and rewritable DVD-RAMs. A DVD-RAM has a lead-in area, data area, and lead-out area.

The data area also includes a user area where user data is recorded, and a drive area. The position and storage capacity of the drive area are determined by a standardized format.

However, as described above, since the position and storage capacity of the drive area are determined by a standardized format, newly defined drive information cannot be stored.

For example, Jpn. Pat. Appln. KOKAI Publication No. 3-250463 discloses a technique of forming a secret area in a file system layer, though it cannot solve the above problem.

### BRIEF SUMMARY OF THE INVENTION

It is an object of the present invention to provide an information recording medium capable of contributing to solve the above problem.

(1) An information recording medium according to an aspect of the present invention comprises a user area defined by a logical address and a physical address, a secret area defined only by a physical address, and an address area which stores the physical address that indicates a position of the secret area.

(2) An information recording medium comprises a user area defined by a logical address and a physical address, a secret area defined only by a physical address, and an address area which stores the physical address that indicates a position of the secret area, and

an information recording apparatus according to an aspect of the present invention records information on the above information recording medium and comprises

a reading section configured to read out a physical address from the address area and to read out a logical address and physical address from the user area, and a recording section configured to record desired data in a secret area defined by the physical address on the basis of the physical address read out from the address area and to record the desired data in the user area defined by the logical address and physical address read out from the user area.

(3) An information recording medium comprises a user area defined by a logical address and a physical address, a secret area defined only by a physical address, and an address area which stores the physical address that indicates a position of the secret area, and

an information playback apparatus according to an aspect of the present invention plays back information from the above information recording medium and comprises

a reading section configured to read out a physical address from the address area and to read out a logical address and physical address from the user area, and a playback section configured to play back desired data from a secret area defined by the physical address on the basis of the physical address read out from the address area and to play back the desired data from the user area defined by the logical address and physical address read out from the user area.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a view showing the layout of a lead-in area, data area, lead-out area, and the like on an optical disk;

FIG. 2 is a view showing the data structure of a sector field on the optical disk;

FIG. 3 is a view showing the structure of ECC block data;

FIG. 4 is a view showing the data structure of sector data recorded on a data field;

FIG. 5 is a view showing the data structure of the entire optical disk and, more particularly, a secret area arranged in the data area;

FIG. 6 is a view showing the data structure of a secret list area where address data that indicates the position of the secret area is stored;

FIG. 7 is a view showing the data structure of the entire optical disk and, more particularly, a logical address space and non-logical address space;

FIG. 8 is a block diagram showing the schematic arrangement of an information recording/playback apparatus;

FIG. 9 is a flow chart for explaining a recording process for the optical disk; and

FIG. 10 is a flow chart for explaining a playback process for the optical disk.

### DETAILED DESCRIPTION OF THE INVENTION

An embodiment of the present invention will be described below with reference to the accompanying drawing.

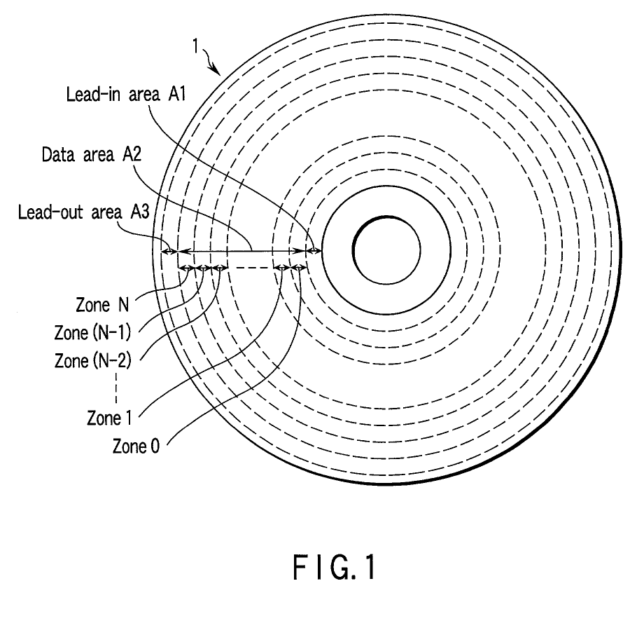

An optical disk (DVD-RAM disk) 1 serving as an information recording medium will be described first with reference to FIG. 1.

FIG. 1 shows the layout of a lead-in area, data area, lead-out area, and the like on an optical disk.

As shown in FIG. 1, a lead-in area A1, data area A2, and lead-out area A3 are assured on an optical disk 1 in turn from the inner periphery side. The lead-in area Al includes an emboss data zone, mirror zone (non-recording zone), and rewritable data zone. The data area A2 includes a rewritable data zone, which includes a plurality of zones 0 to N. The lead-out area A3 includes a rewritable data zone.

On the emboss data zone in the lead-in area A1, a reference signal and control data are recorded as a embossed pattern upon manufacturing the optical disk 1. On the rewritable data zone in the lead-in area A1, identification data for identifying the type of disk, defect management data for managing defective areas, and the like are recorded. Note that an area where the defect management data is recorded will be referred to as a DMA (Defect Management Area) hereinafter. On the rewritable data zone in the lead-out area A3, the same data as those recorded on the rewritable data zone in the lead-in area A1 are recorded.

The emboss data zone in the lead-in area A1 consists of a plurality of tracks, each of which consists of a plurality of sector fields. This zone is processed at a predetermined rotational speed.

Each of the rewritable data zone in the lead-in area A1 and zone 0 of the rewritable data zone in the data area A2 consists of X tracks, each of which consists of Y sector fields. This zone is processed at a rotational speed Z0 (Hz).

Zone 1 of the rewritable data zone in the data area A2 consists of X tracks, each of which consists of (Y+1) sector fields. This zone is processed at a rotational speed Z1 (Hz).

Zone 2 of the rewritable data zone in the data area A2 consists of X tracks, each of which consists of (Y+2) sector fields. This zone is processed at a rotational speed Z2 (Hz) (Z1>Z2).

Each of zones 3 to N of the rewritable data zone in the data area A2 consists of X tracks. Each track in zone 3 consists of (Y+3) sector fields, and each track in zone 4 consists of (Y+4) sector fields. That is, each track in zone N consists of (Y+N) sector fields. Zone 3 is processed at a rotational speed Z3 (Hz) (Z2>Z3), and zone 4 is processed at a rotational speed Z4 (Hz) (Z3>Z4). That is, zone N is processed at a rotational speed ZN (Hz) (Z(N−1)>ZN).

The rewritable data zone in the lead-out area A3 consists of a plurality of tracks, each of which consists of (Y+N) sector fields. This zone is processed at a rotational speed ZN (Hz).

As described above, the number of sector fields per track increases and the rotational speed lowers in turn from the zones on the inner periphery side of the optical disk 1. That is, the optical disk 1 is compatible with the ZCLV (Zone Constant Linear Velocity) scheme.

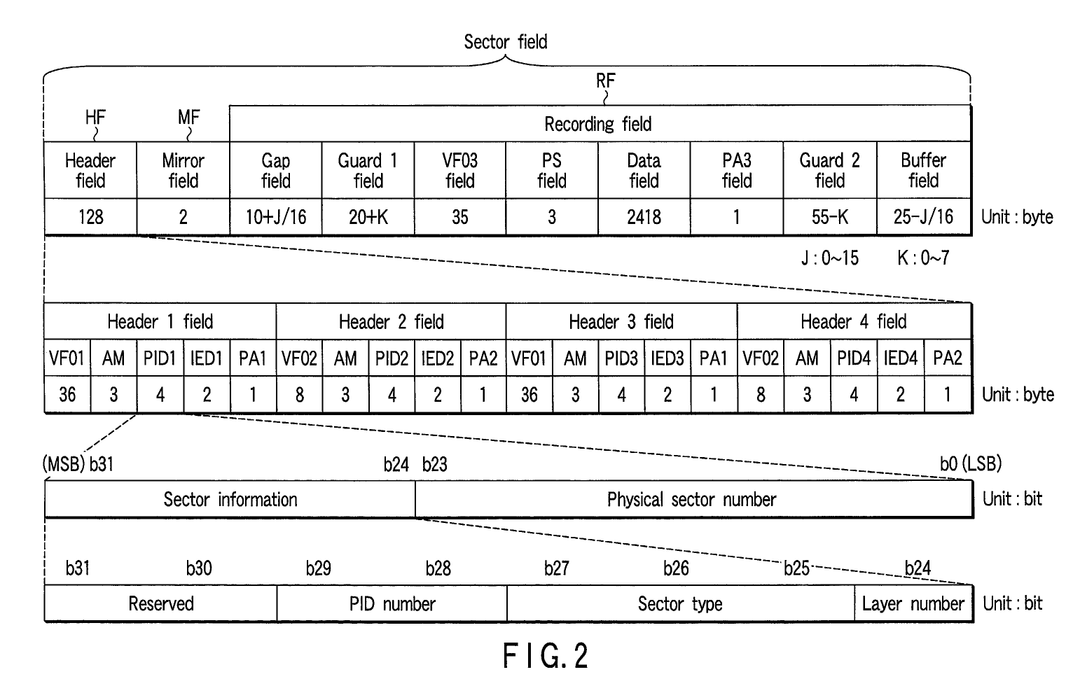

Subsequently, the format of a sector field on the DVD-RAM disk will be explained below with reference to FIG. 2.

As shown in FIG. 2, one sector field consists of nearly 2,697 bytes. This sector field records data modulates by 8-16 modulation. 8-16 modulation modulates an 8-bit input code sequence into a 16-bit output code sequence. The input code sequence is called input bits, and the output code sequence channel bits. Note that 1 byte means 16 channel bits.

The contents of one sector field will be explained below. One sector field is constructed by a 128-byte header field HF, 2-byte mirror field MF, and 2,567-byte recording field RF.

The header field HF records header data as an embossed pattern in the manufacturing process of the optical disk. In this header field HF, header data is written four times to improve detection precision of header data. That is, this header field HF contains a header 1 field, header 2 field, header 3 field, and header 4 field. Each of the header 1 field and header 3 field consists of 46 bytes. Each of the header 2 field and header 4 field consists of 18 bytes.

The header 1 field contains 36-byte VFO (Variable Frequency Oscillator) 1, 3-byte AM (Address Mark), 4-byte PID (Physical ID) 1, 2-byte IED (ID Error Detection Code) 1, and 1-byte PA (Post Ambles) 1.

The header 2 field contains 8-byte VFO2, 3-byte AM, 4-byte PID2, 2-byte IED2, and 1-byte PA2.

The header 3 field contains 36-byte VFO1, 3-byte AM, 4-byte PID3, 2-byte IED3, and 1-byte PA1.

The header 4 field contains 8-byte VFO2, 3-byte AM, 4-byte PID4, 2-byte IED4, and 1-byte PA2.

Each of the PID1, PID2, PID3, and PID4 contains sector information and a physical sector number (physical address). Each of the VFO1 and VFO2 contains a continuous repetitive pattern (100010001000 . . . ) for a PLL (Phase Locked Loop) process. The AM contains a special mark (address mark) which violates a constraint length for indicating the PID position. Each of the IED1, IED2, IED3, and IED4 contains an error detection code for detecting a PID error. The PA contains state information required for demodulation, and also has a role of polarity adjustment to terminate the header field HF with a space. The mirror field MF stores mirror data.

The recording field RF records user data. The recording field contains a (10+J/16)-byte gap field, (20+K(-byte guard 1 field, 35-byte VFO3 field, 3-byte PS (pre-synchronous code) field, 2,418-byte data field (user data field), 1-byte post amble PA3 field, (55-K)-byte guard 2 field, and (25−J/16)-byte buffer field. Note that J assumes a random integer ranging from 0 to 15, and K assumes a random integer ranging from 0 to 7. In this manner, the data write start position is randomly shifted. As a result, deterioration of a recording film due to overwrite can be minimized.

The gap field records no data. The guide 1 field is a sacrificed area for absorbing leading edge deterioration caused by repetitive overwrite processes, which is unique to a phase-change recording film. The VFO3 field is a PLL lock field, and also has a roll of synchronizing byte boundaries by inserting a synchronous code in identical patterns. The PS code records a synchronous code.

The data field records a data ID, IED (Data ID Error Detection Code), synchronous code, ECC (Error Correction Code), EDC (Error Detection Code), 2,048-byte user data, and the like. The data ID contains a logical sector number (logical address). The IED is a 2-byte (16-bit) error correction code for the data ID.

The PA3 field contains state information required for demodulation, and indicates the end of the last byte in the previous data field. The guard 2 field prevents trailing edge deterioration upon repetitive recording, which is also unique to a phase-change recording medium, from influencing the data field. The buffer field absorbs variations of rotation of a motor for rotating the optical disk 1 and the like to prevent the data field from overlapping the next header field.

The PID1, PID2, PID3, and PID4 will be explained in detail below. Each of these PIDs contains 8-bit sector information, and a 24-bit physical sector number. The physical sector number records address data indicating the absolute position of the sector field. The sector information contains information such as a 2-bit reserved area, 2-bit physical ID number, 3-bit sector type, 1-bit layer number, and the like. The reserved area is a non-recording area.

The physical ID numbers in the header 1, 2, 3, and 4 fields record “00”, “01”, “10”, and “11” indicating the PID1, PID2, PID3, and PID4, respectively.

The sector type records “000” or “011” indicating a reserved sector; “100” indicating a rewritable first sector in a track; “101” indicating a rewritable last sector in a track; “110” indicating a rewritable last but one sector in a track; or “111” indicating a rewritable other sector in a track.

The layer number records “0” indicating layer 0, or “1” indicating “reserved”.

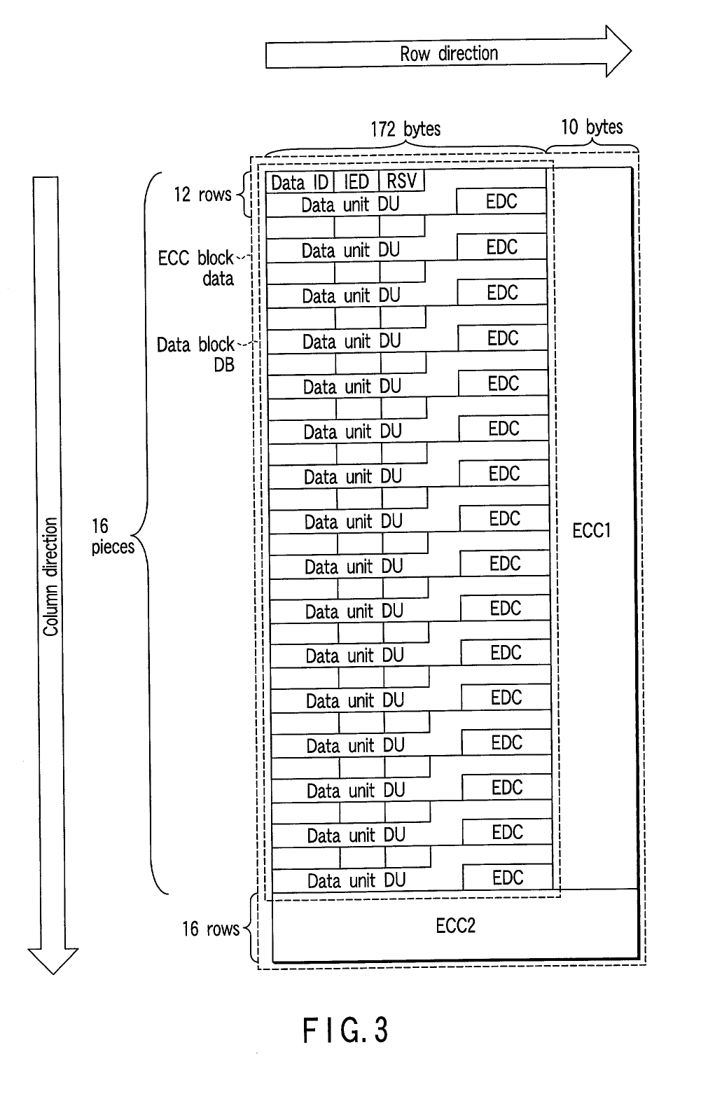

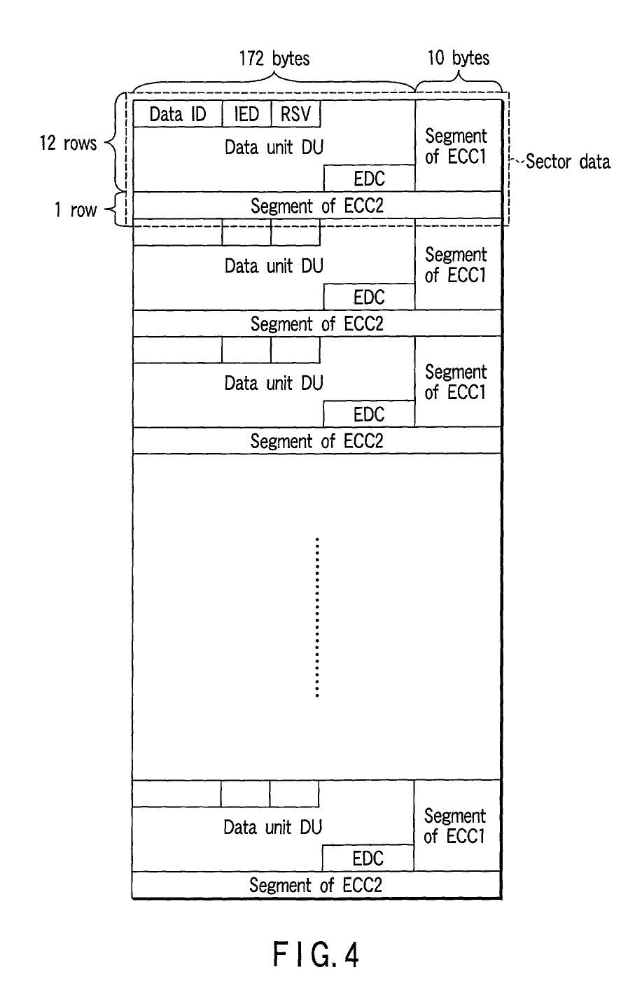

The data structures of the ECC block data and sector data will be explained below with reference to FIGS. 3 and 4. FIG. 3 shows the data structure of the ECC block data. FIG. 4 shows the data structure of the sector data recorded in the data field shown in FIG. 2.

Tracks are formed on a DVD-RAM, and a plurality of sector fields are formed in each track. In other words, a plurality of successive sector fields form a track. The DVD-RAM records data in a format called ECC block data. Strictly speaking, 16 sector data generated based on the ECC block data are distributed and recorded in 16 sector fields. In addition, a group of sector data is recorded in the 2,418-byte data field shown in FIG. 2.

As shown in FIG. 3, the ECC block data consists of a data block DB (user data, and the like), ECC1, and ECC2.

The data block DB is constructed by an array of data which has a predetermined number of rows and columns, and can be segmented into 16 data units. More specifically, the data block DB is constructed by 172 (bytes)×12 (the number of rows forming each data unit)×16 (the number of data units forming the data block) data. Each data unit DU is constructed by 172 (bytes)×12 (the number of rows forming each data unit) data. Each data unit DU contains a data ID, IED, EDC, 2,048-byte user data, and the like. The data ID is used for scrambling user data contained in the data unit DU. The EDC is used for detecting any error contained in a set of data in the data unit.

The ECC1 is used for correcting LRC errors in the data block DB. More specifically, the ECC1 is constructed by 10 (bytes)×12 (the number of rows forming each data unit DU)×16 (the number of data units forming the data block) data. This ECC1 has error correction performance that normally corrects errors up to 5 bytes, and corrects errors up to 10 bytes upon erasure correction.

The ECC2 is used for correcting VRC errors in the data block DB. More specifically, the ECC2 is constructed by {172 (bytes)+10 (bytes)}×16 (the number of data units forming the data block) data. This ECC2 has error correction performance that normally corrects errors up to 8 bytes, and corrects errors up to 16 bytes upon erasure correction.

The sector data will be explained below with the aid of FIG. 4.

Sixteen sector data are generated from one ECC block data. One sector data consists of a data unit DU, a segment of the LRC error correction code ECC1, and a segment of the VRC error correction code ECC2, which is assigned to this data unit DU. More specifically, the sector data is composed of {172 (bytes)+10 (bytes)}×{12 (the number of rows forming each data unit DU)+1 (for one column of the VRC error correction code ECC2)} data.

The data structure of the entire disk and, more particularly, the data structure of the lead-in area A1, data area A2, and lead-out area A3 will be described next with reference to FIG. 5. A total of four defect management areas are arranged on the optical disk. Identical data are recorded in these defect management areas. Two (DMA1 and DMA2) of the four defect management areas (DMA1 to DMA4) are arranged in the lead-in area. The remaining two defect management areas (DMA3 and DMA4) are arranged in the lead-out area.

Each of the defect management areas (DMA1 to DMA4) includes a PDLA (Primary Defect List Area) a1, SDLA (Secondary Defect List Area) a2, and SLA (Spare List Area) a3. Note that a Primary Defect is also called a first-stage defect. The PDLA a1 has a plurality of PDLs (Primary Defect Lists) as entries. The SDLA a2 has a plurality of SDLs (Secondary Defect Lists) as entries. The SLA a3 has a plurality of SALs (Spare Area Lists) as entries.

A replacement process using the above-described defect lists will be described below. The replacement process includes a slipping replacement process and a linear replacement process. The slipping replacement process is done for primary defects in units of sector fields. The linear replacement process is done for secondary defects in units of ECC block data. These processes will be described in detail below.

The slipping replacement process will be explained first.

Before delivery of an optical disk, it is certified if the rewritable data zone on the optical disk suffers defects (primary defects). That is, it is certified if data can be normally recorded in the rewritable data zone. This certification is done in units of sector fields.

During the certification, if a defective sector (indicating a sector field including defects) is found, the physical sector number of this defective sector is recorded in the PDL. Furthermore, no logical sector number is assigned to this defective sector. More specifically, logical sector numbers are assigned to only normal sectors (indicating sector fields free from any defects) allocated before and after this defective sector by ignoring the defective sector. That is, the defective sector is considered as a non-existing sector. In this manner, user data or the like is prevented from being written in such defective sector. A series of processes mentioned above are done in the slipping replacement process. Thus, the defective sectors are slipped in this slipping replacement process.

Second, the linear replacement process will be explained.

When user data is written after delivery of an optical disk, it is verified if the user data is normally written. A situation that user data cannot be normally written is called a secondary defect. The presence/absence of secondary defects is verified in units of 16 sector fields (i.e., in units of blocks) each of which records the ECC block data shown in FIG. 3.

If a defective block (indicating a block including secondary defects) is found, the physical sector number of the first sector in the defective block and the physical sector number of the first sector in a replacement block (indicating a block to be assured in the spare area) that is to replace the defective block are recorded in the SDL. Also, the logical sector numbers assigned to 16 sector fields in the defective block are assigned to 16 sector fields in the replacement block. In this manner, data to be recorded in the defective block is recorded in the replacement block. After that, access to the defective block is considered as that to the replacement block. A series of processes mentioned above are done in the linear replacement process. That is, in this linear replacement process, a defective block is linearly replaced.

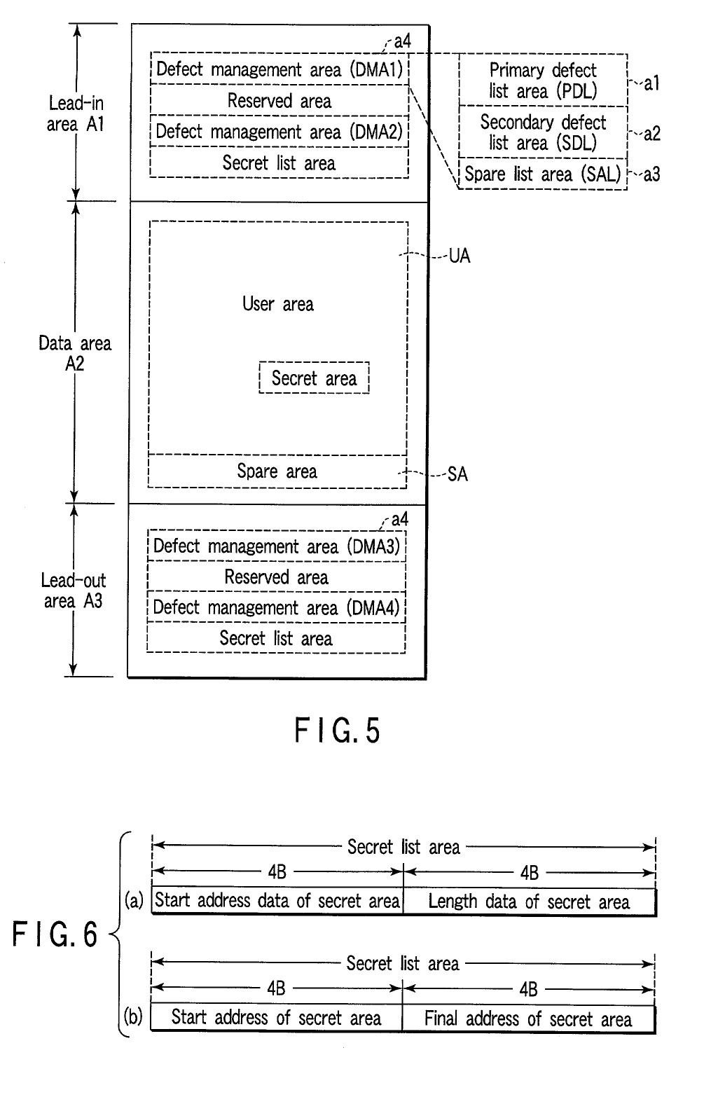

Referring back to FIG. 5, each of the lead-in area A1 and lead-out area A3 has a secret list area (address area). Address data that indicates the position of a secret area is stored in the secret list area, as shown in FIG. 6. For example, as shown in (a) of FIG. 6, the start address data (4 bytes) of a secret area and the length data (4 bytes) of the secret area are stored. Alternatively, as shown in (b) of FIG. 6, the start address data (4 bytes) and final address data (4 bytes) of a secret area are stored. The secret area whose position is indicated by the address data is defined in the data area (especially in the user area). That is, the secret area is subjected to a replacement process. With this structure, the reliability of data stored in the secret area can be maintained.

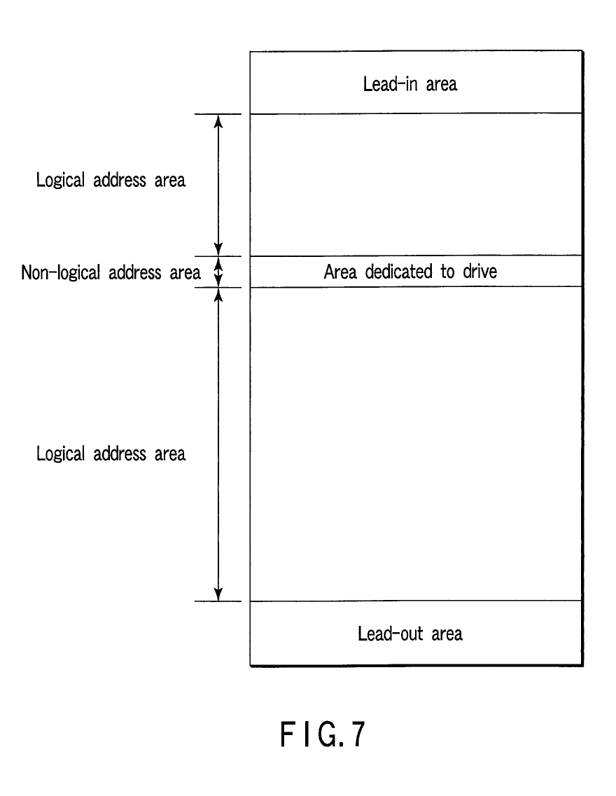

The user area normally has a physical address and logical address and is accessed from the host using the logical address. When viewed from the host, a series of areas having logical addresses can be handled as a logical space (logical address space shown in FIG. 7). This user area is managed by a file system. However, it is sometimes not preferable to place information to be processed only by the drive in an area accessible from the host. Examples of such information are information directly related to a physical process and access control information. When access control information or the like, which is not defined in advance, is to be stored, a capacity necessary for it cannot be set in advance. Hence, a mechanism that arbitrarily sets a secret area (non-logical address space shown in FIG. 7) that cannot be directly accessed from the host is used. As described above, a secret area is designated by the start physical address and length (sector length) or the start physical address and end physical address of that area. This designation is recorded in, e.g., the lead-in area (or also in the lead-out area) where various kinds of information of the optical disk are recorded. The position information of the secret area recorded in the lead-in area is also secret. The size of the secret area can be designated from the host. Once the size of the secret area is designated from the host, the drive sets the secret area at an appropriate position and executes addressing without assigning any logical address to the secret area. That is, the secret area is formatted as an area (an area dedicated to the drive) that cannot be directly accessed from the host.

A plurality of secret areas may be defined. In this case, a plurality of address data that indicate the positions of the plurality of secret areas are registered in the secret list area. For the sake of simplicity, the number of secret areas may be limited to one. For operation, the secret area is preferably set upon formatting. However, this setting may be executed after formatting if communication with the host is possible. However, if the secret area is to be set after formatting, a certain process for preventing any erasure of user data is executed. The secret area undergoes defect management, like a normal data area.

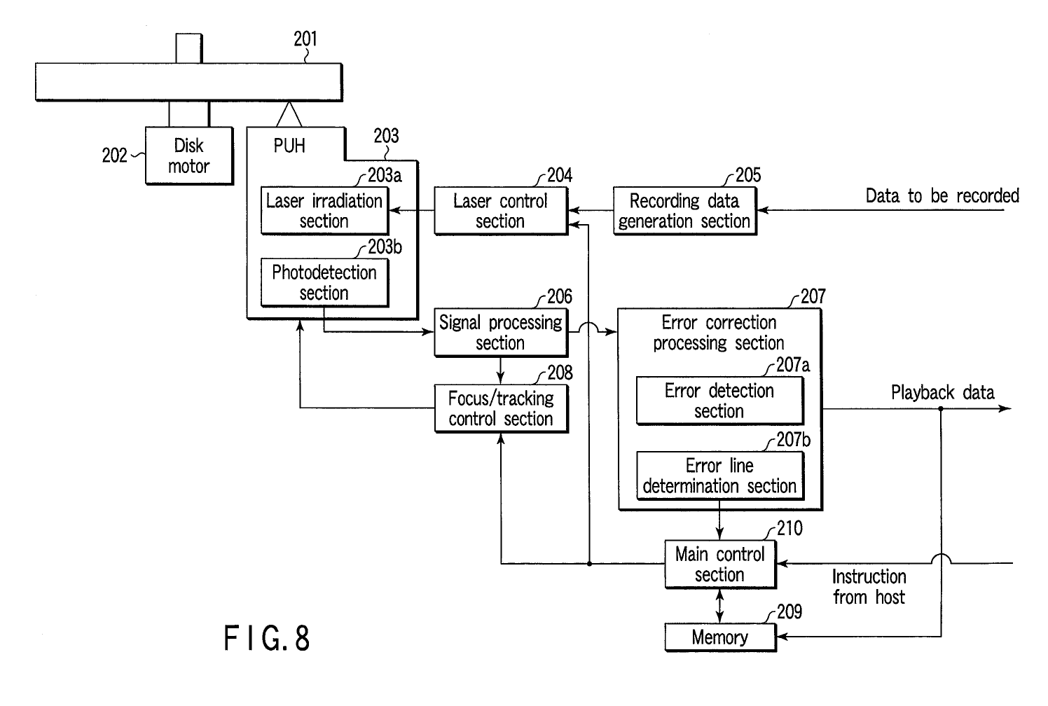

The schematic arrangement of an information recording/playback apparatus will be described below with reference to FIG. 8. The information recording/playback apparatus shown in FIG. 8 records predetermined data on the optical disk 1 corresponding to the information recording medium of the present invention or plays back information recorded on the optical disk 1. The information recording/playback apparatus comprises a disk motor 202, PUH (PickUp Head) 203, laser control section 204, recording data generation section 205, signal processing section 206, error correction processing section 207, focus/tracking control section 208, memory 209, main control section 210, and the like.

The disk motor 202 rotates the optical disk 1 at a predetermined rotational speed. The PUH 203 has a laser irradiation section 203a and photodetection section 203b. The laser irradiation section 203a selectively irradiates the optical disk with one of a recording light beam and playback light beam that have different irradiation powers. The photodetection section 203b detects reflected light, from the optical disk, of the light beam emitted from the laser irradiation section 203a. The laser control section 204 ON/OFF-controls the laser irradiation section 203a and also controls the irradiation power of the light beam to be emitted from the laser irradiation section 203a. The recording data generation section 205 adds an error correcting code to data to be recorded, thereby generating recording data.

The signal processing section 206 plays back data reflected on the reflected light detected by the photodetection section 203b. The error correction processing section 207 corrects an error contained in the play back data on the basis of the error correcting code contained in the data played back by the signal processing section 206. The error correction processing section 207 has an error detection section 207a and error line determination section 207b. The error detection section 207a detects the number of error bytes contained in play back data in one line on the basis of the error correcting code contained in the data played back by the signal processing section 206. The error line determination section 207b determines on the basis of the error detection result whether the played back line corresponds to an error line. For example, a line containing errors of 5 bytes or more is determined as an error line. When a line contains errors up to 4 bytes, the line can be corrected by the error correcting capability of the error correcting code. However, if a line contains more error bytes, it cannot be corrected by the error correcting code. For this reason, a line containing errors of 5 bytes or more is determined as an error line.

The focus/tracking control section 208 controls focus and tracking of a light beam emitted from the PUH 203 on the basis of the data played back by the signal processing section 206. The memory 209 stores various kinds of control information in advance. The memory 209 also stores various kinds of control information read out from the optical disk. The main control section 210 controls the information recording/playback apparatus on the basis of instructions from a host apparatus 3 and the various kinds of control information stored in the memory 209 to record desired information on the optical disk 1 or play back desired information recorded on the optical disk 1.

A recording process for recording information on the optical disk 1 and a playback process for playing back information from the optical disk 1 by the above-described information recording/playback apparatus will be described.

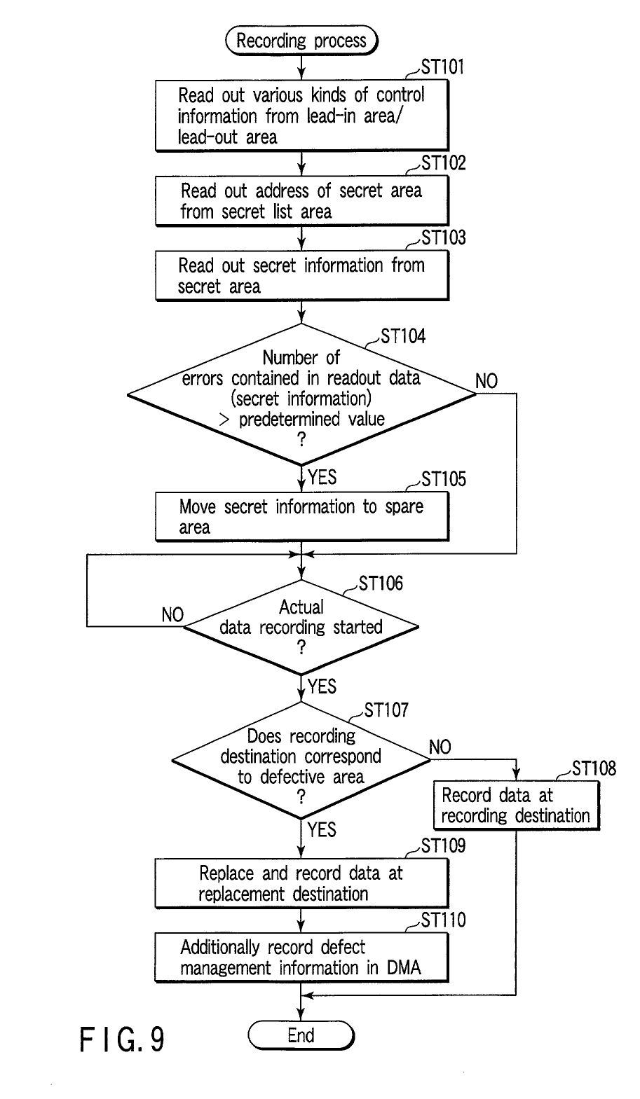

The recording process will be described with reference to FIG. 9. When the optical disk 1 is loaded in the information recording/playback apparatus, the main control section 210 instructs to read the lead-in area and lead-out area. On the basis of this instruction, the laser control section 204 controls the laser irradiation section 203a. Simultaneously, the focus/tracking control section 208 starts controlling focus/tracking. Various kinds of control information are read out from the lead-in area and lead-out area (ST101). At this time, the address data of a secret area are read out from the secret list areas in the lead-in area and lead-out area (ST102). The secret area is accessed on the basis of the address data to read out secret information from the secret area (ST103). The readout secret information is stored in the memory 209.

As already described above, the secret area is arranged in the user area. Hence, the secret area undergoes defect management whereby the reliability of the secret information stored in the secret area can be maintained. When secret information is read out from the secret area, the secret area is recorded in a replacement destination under a predetermined condition serving as a criterion. For example, when the number of errors contained in the readout data (secret information) exceeds a predetermined value (YES in ST104), the secret information is recorded in a replacement destination. That is, the secret information is moved to a spare area (ST105). At this time, the spare area (replacement destination of the secret area) where the secret information is stored is defined only by a physical address. No logical address is assigned. When the secret information is recorded in the spare area as a replacement destination, the address data of the secret area, which is stored in the secret list area, is rewritten. That is, the address is rewritten to an address indicating the secret area in the spare area. If the number of errors contained in the readout data is equal to or smaller than a predetermined value (NO in ST104), the secret information is not recorded in a replacement destination. For example, a condition may be set such that the secret information is recorded in a replacement destination before the number of errors exceeds the error correction capability of the ECC.

When the host apparatus instructs to record desired data at a desired address in the user area, a recording process of the desired data for the desired address is executed under the control of the main control section 210 (YES in ST106). If it is determined on the basis of the defect management information that the recording designation at the desired address does not correspond to any defective area (NO in ST107), the desired data is recorded at the desired address (ST108). If it is determined on the basis of the defect management information that the recording designation at the desired address corresponds to a defective area (YES in ST107), the desired data is recorded at an address (spare address) as a replacement destination corresponding to the desired address (ST109). In addition, information representing that the data is recorded in a replacement destination is additionally recorded in the DMA (ST110).

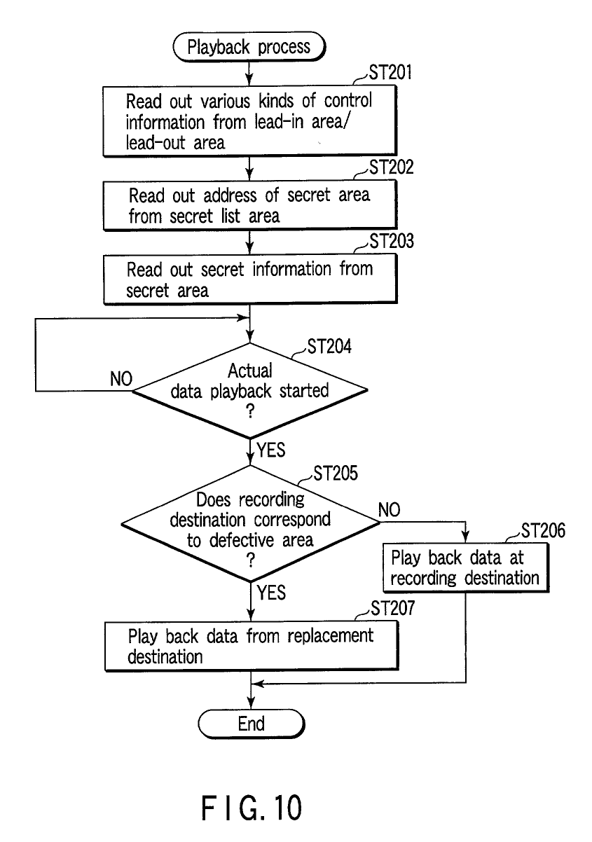

The playback process will be described next with reference to FIG. 10. When the optical disk 1 is loaded in the information recording/playback apparatus, the main control section 210 instructs to read the lead-in area and lead-out area. On the basis of this instruction, the laser control section 204 controls the laser irradiation section 203a. Simultaneously, the focus/tracking control section 208 starts controlling focus/tracking. Various kinds of control information are read out from the lead-in area and lead-out area (ST201). At this time, the address data of the secret area are read out from the secret list areas in the lead-in area and lead-out area (ST202). The secret area is accessed on the basis of the address data to read out secret information from the secret area (ST203). The readout secret information is stored in the memory 209.

When the host apparatus instructs to play back desired data from a desired address in the user area, a playback process of the desired data from the desired address is executed under the control of the main control section 210 (YES in ST204). If it is determined on the basis of the defect management information that the recording designation at the desired address does not correspond to any defective area (NO in ST205), the desired data is played back from the desired address (ST206). If it is determined on the basis of the defect management information that the recording designation at the desired address corresponds to a defective area (YES in ST205), the desired data is played back from a spare area at the replacement destination of the defective area (ST207).

According to the above-described embodiment, the following medium and apparatuses can be obtained.

(1) An information recording medium capable of storing secret information that cannot be accessed from a host (host device).

(2) An information recording apparatus capable of properly recording information on an information recording medium capable of storing secret information that cannot be accessed from a host (host device).

(3) An information playback apparatus capable of properly playing back information on an information recording medium capable of storing secret information that cannot be accessed from a host (host device).

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information recording medium comprising:
a user area defined by a logical address and a physical address;
a secret area defined only by a physical address; and
an address area which stores the physical address that indicates a position of said secret area.

2. A medium according to claim 1, further comprising
a data area for recording user data, and
a management area for recording management information,
said data area comprising the user area and the secret area, and
said management area comprising the address area.

3. A medium according to claim 1, further comprising
a data area for recording user data, which undergoes defect management, and
a management area for recording management information, which does not undergo defect management,
said data area comprising the user area, the secret area, and a spare area serving as a replacement destination of a defective area that may exist in said data area, and
said management area comprising the address area and a defect management area which stores defect management information representing a relationship between the defective area and the spare area.

4. An information recording apparatus which records information on an information recording medium, comprising:
a first reading section configured to read out a physical address from an address area of the information recording medium and to read out a logical address and physical address from a user area of the information recording medium; and
a recording section configured to record desired data in a secret area defined by the physical address on the basis of the physical address read out from the address area and to record the desired data in the user area defined by the logical address and physical address read out from the user area,
wherein the information recording medium comprises
the user area defined by the logical address and physical address,
the secret area defined only by the physical address, and
the address area which stores the physical address that indicates a position of the secret area.

5. An apparatus according to claim 4, wherein
said apparatus further comprises
a second reading section configured to read out defect management information from a defect management area of the information recording medium,
a replacement recording section configured, when it is determined on the basis of the defect management information read out from the defect management area and the physical address read out from the address area that the secret area defined by the physical address does not correspond to a defective area for recording the desired data in the secret area, and when it is determined that the secret area defined by the physical address corresponds to a defective area, to record the desired data in a spare area serving as a replacement destination of the secret area, and
a defect management information recording section configured to record information representing that replacement and recording have been executed by said replacement recording section in the defect management area, and
the information recording medium comprises
a data area for recording user data, which undergoes defect management, and
a management area for recording management information, which does not undergo defect management,
the data area comprising the user area, the secret area, and a spare area serving as a replacement destination of a defective area that may exist in the data area, and
the management area comprising the address area and a defect management area which stores defect management information representing a relationship between the defective area and the spare area.

6. An information playback apparatus which plays back information from an information recording medium, comprising:
a first reading section configured to read out a physical address from an address area of the information recording medium and to read out a logical address and physical address from a user area of the information recording medium; and
a playback section configured to play back desired data from a secret area defined by the physical address on the basis of the physical address read out from the address area and to play back the desired data from the user area defined by the logical address and physical address read out from the user area,
wherein the information recording medium comprises
the user area defined by the logical address and physical address,
the secret area defined only by the physical address, and
the address area which stores the physical address that indicates a position of the secret area.

7. An apparatus according to claim 6, wherein
said apparatus further comprises
a second reading section configured to read out defect management information from a defect management area of the information recording medium, and
a replacement playback section configured, when it is determined on the basis of the defect management information read out from the defect management area and the physical address read out from the address area that the secret area defined by the physical address does not correspond to a defective area, to play back the desired data from the secret area, and when it is determined that the secret area defined by the physical address corresponds to a defective area, to play back the desired data from a spare area serving as a replacement destination of the secret area, and
the information recording medium comprises
a data area for recording user data, which undergoes defect management, and
a management area for recording management information, which does not undergo defect management,
the data area comprising the user area, the secret area, and a spare area serving as a replacement destination of a defective area that can exist in the data area, and
the management area comprising the address area and a defect management area which stores defect management information representing a relationship between the defective area and the spare area.
